(19) United States
(12) Patent Application Publication
(10) Pub. No.: US 2022/0332307 A1
(43) Pub. Date: Oct. 20, 2022

(54) DISTURBANCE HANDLING FOR TRAILER TOWING

(71) Applicant: Continental Advanced Lidar Solutions US, LLC, Carpinteria, CA (US)

(72) Inventors: Jeremy J McClain, Oberursel (DE); Marcus David Christensen, Davisburg, MI (US); Dominik Froehlich, Ferndale, MI (US)

(73) Assignee: Continental Advanced Lidar Solutions US, LLC, Carpinteria, CA (US)

(21) Appl. No.: 17/753,339

(22) PCT Filed: Aug. 28, 2020
(86) PCT No.: PCT/US2020/048458

§ 371 Date: Feb. 28, 2022

Related U.S. Application Data
(60) Provisional application No. 62/892,940, filed on Aug. 28, 2019.

(51) Int. Cl. B60W 30/02; B60W 30/18; B60W 50/14; B60W 40/10

(52) U.S. Cl. CPC B60W 30/02; B60W 30/18163; B60W 50/14; B60W 40/10; B60W 2554/4041; B60W 2554/4042; B60W 2554/804; B60W 2554/801; B60W 2530/203; B60W 2710/18; B60W 2754/20; B60W 2720/10; B60W 2554/20; B60W 2552/10

(57) ABSTRACT

A method for minimizing disturbance due to wind forces of a trailer being towed by a vehicle. The method also includes receiving, at a data processing hardware data from a sensor system for the tow vehicle. The method also includes determining, at the data processing hardware, a passing object profile. The method also includes predicting, at the data processing hardware, a wind force profile based upon the sensor data the passing object profile. The method also includes determining, at the data processing hardware, at least one preventative action for the vehicle to minimize the effect of disturbance on the trailer.

### CROSS REFERENCE TO RELATED APPLICATIONS

This U.S. patent application claims the benefit of U.S. provisional patent application No. 62/892,940, filed Aug. 28, 2019, which is hereby incorporated by reference.

### TECHNICAL FIELD

This disclosure relates to a tow vehicle configured to attach to a trailer. The tow vehicle having a stability control system for increasing lateral trailer stability.

### BACKGROUND

Trailers are usually unpowered vehicles that are pulled by a powered tow vehicle. A trailer may be a utility trailer, a popup camper, a travel trailer, livestock trailer, flatbed trailer, enclosed car hauler, and boat trailer, among others. The tow vehicle may be a car, a crossover, a truck, a van, a sports-utility-vehicle (SUV), a recreational vehicle (RV), or any other vehicle configured to attach to the trailer and pull the trailer. The trailer may be attached to a powered vehicle using a trailer hitch. A receiver hitch mounts on the tow vehicle and connects to the trailer hitch to form a connection. The trailer hitch may be a ball and socket, a fifth wheel and gooseneck, or a trailer jack. Other attachment mechanisms may also be used. In addition to the mechanical connection between the trailer and the powered vehicle, in some example, the trailer is electrically connected to the tow vehicle. As such, the electrical connection allows the trailer to take the feed from the powered vehicle's rear light circuit, allowing the trailer to have taillights, turn signals, and brake lights that are in sync with the powered vehicle's lights.

Trailers have a tendency to sway in the lateral direction when they are traveling, particularly, at high rate of speed, and in windy situations whether from traffic or the weather.

Therefore, it is desirable to have a system that detects when there is trailer movement due to wind and provides correction to compensate for sway induced by the wind.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One general aspect includes a method for minimizing disturbance due to wind forces of a trailer being towed by a vehicle. The method also includes receiving, at a data processing hardware data from a sensor system for the tow vehicle. The method also includes determining, at the data processing hardware, a passing object profile. The method also includes predicting, at the data processing hardware, a wind force profile based upon the sensor data the passing object profile. The method also includes determining, at the data processing hardware, at least one preventative action for the vehicle to minimize the effect of disturbance on the trailer. Other embodiments of this aspect include corresponding computer systems, apparatus, and computer programs recorded on one or more computer storage devices, each configured to perform the actions of the methods.

Implementations may include one or more of the following features. The method where the passing object profile includes at least one of: the passing object size, passing object speed, relative speed of the passing object to the vehicle, and lateral distance of the passing object to the vehicle.

The wind force profile is determined based upon stored object data associated with the passing object profile.

The passing object is a stationary object the vehicle is driving past.

The at least one preventative action may include: warning a driver, calculating a trailer oscillation threshold, adjusting the trailer oscillation threshold based on the predicted wind force, braking the tow vehicle below a critical mass moment inertia of the vehicle and trailer system, adapting the stability control sensitivity, asymmetrically braking the front axle of the tow vehicle, inducing a preventative steering oscillation, increasing a distance between the trailer and the passing vehicle, and adjusting a speed of at least one motor of the tow vehicle.

Increasing the distance between the trailer and the passing vehicle further may include moving within the current lane of travel to maximize the lateral distance between the trailer and the passing vehicle.

The sensor data includes a lateral force from the wind on the tow vehicle and the at least one preventative action is taken prior to a substantial portion of the wind force acting upon the trailer. Implementations of the described techniques may include hardware, a method or process, or computer software on a computer-accessible medium.

One general aspect includes a method for minimizing disturbance due to wind forces of a trailer being towed by a vehicle. The method also includes receiving, at a data processing hardware data from a sensor system for the tow vehicle, where the sensor data includes a lateral force from then wind on one of the tow vehicle and the trailer. The method also includes determining, at the data processing hardware, a passing object profile. The method also includes calculating, at the data processing hardware, a wind force profile based upon the sensor data the passing object profile. The method also includes determining, at the data processing hardware, at least one corrective action for the vehicle to minimize the effect of disturbance on the trailer. Other embodiments of this aspect include corresponding computer systems, apparatus, and computer programs recorded on one or more computer storage devices, each configured to perform the actions of the methods.

Implementations may include one or more of the following features. The method where the passing object profile includes at least one of: the passing object size, passing object speed, relative speed of the passing object to the vehicle, and lateral distance of the passing object to the vehicle.

The wind force profile is determined based upon stored object data associated with the passing object profile.

The passing object is a stationary object the vehicle is driving past.

The stability actions may include: calculating a trailer oscillation threshold, adjusting the trailer oscillation threshold based on the measured wind force, braking the tow vehicle below a critical mass moment inertia of the vehicle and trailer system, adapting the stability control sensitivity, asymmetrically braking the front axle of the tow vehicle, inducing a steering oscillation, increasing a distance between the trailer and the passing vehicle, and adjusting a speed of at least one motor of the tow vehicle.

Increasing the distance between the trailer and the passing vehicle further may include moving within the current lane of travel to maximize the lateral distance between the trailer and the passing vehicle.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

### DESCRIPTION OF DRAWINGS

FIG. 1 is a schematic view of an exemplary tow vehicle having a trailer hitched thereto.

FIG. 3 is a schematic view of an exemplary tow vehicle having a trailer stability control system.

FIG. 3 is a schematic view of an exemplary tow vehicle having a trailer hitched thereto and in an exemplary high wind scenario.

FIG. 4 is a schematic view of an exemplary tow vehicle having a trailer hitched illustrating the exemplary high wind flow of the scenario of FIG. 3.

FIG. 5 illustrates a schematic view of an exemplary embodiment of predictive and corrective actions that can be implemented by the stability control system to minimize disturbance of the trailer due to a particular wind profile.

Like reference symbols in the various drawings indicate like elements.

### DETAILED DESCRIPTION

A tow vehicle, such as, but not limited to a car, a crossover, a truck, a van, a sports-utility-vehicle (SUV), and a recreational vehicle (RV) may be configured to tow a trailer. The tow vehicle connects to the trailer by way of a trailer hitch. It is desirable to have a tow vehicle that includes stability control to maintain the trailer stability while traveling down the road, especially at high speeds, or in situations with high wind rates.

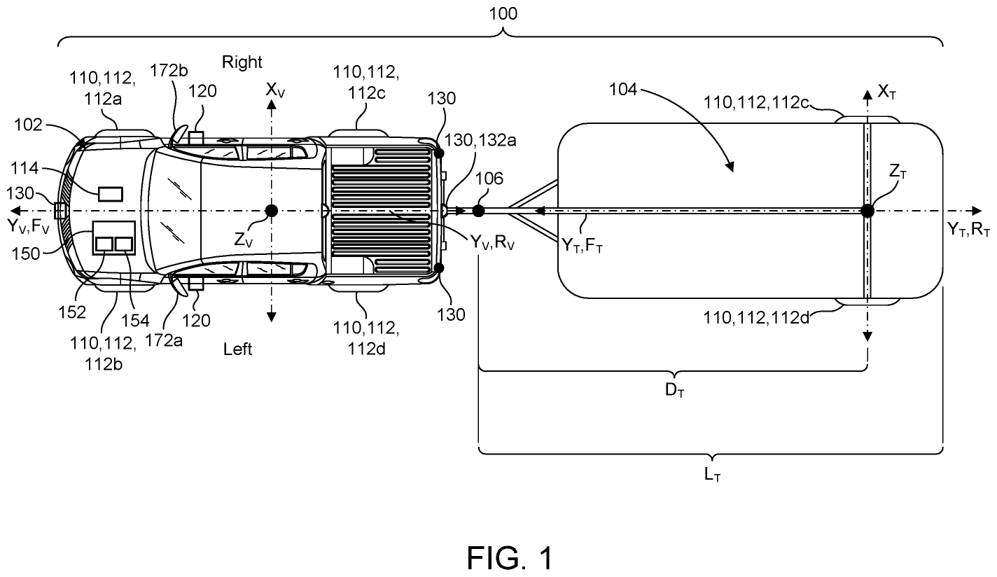

Referring to FIGS. 1 and 2, in some implementations, a vehicle-trailer system 100 includes a tow vehicle 102 hitched to a trailer 104 by way of a hitch 106. The tow vehicle 102 includes a drive system 110 associated with the tow vehicle 102 that maneuvers the tow vehicle 102 and thus the vehicle-trailer system 100 across a road surface based on drive maneuvers or commands having x, y, and z components, for example. As shown, the drive system 110 includes a front right wheel 112, 112a, a front left wheel 112, 112b, a rear right wheel 112, 112c, and a rear left wheel 112, 112d. In addition, the drive system 110 may include wheels (not shown) associated with the trailer 104. The drive system 110 may include other wheel configurations as well. The drive system 110 may include a motor or an engine 114 that converts one form of energy into mechanical energy allowing the vehicle 102 to move. The drive system 110 includes other components (not shown) that are in communication with and connected to the wheels 112 and engine 114 and that allow the vehicle 102 to move, thus moving the trailer 104 as well. The drive system 110 may also include a brake system 120 that includes brakes (not shown) associated with each wheel 112, 112a-d, where each brake is associated with a wheel 112a-d and is configured to slow down or stop the wheel 112a-n from rotating. In some examples, the brake system 120 is connected to one or more brakes supported by the trailer 104. The drive system 110 may also include an acceleration system 122 that is configured to adjust a speed of the tow vehicle 102 and thus the vehicle-trailer system 100, and a steering system 124 that is configured to adjust a direction of the tow vehicle 102 and thus the vehicle-trailer system 100. The vehicle-trailer system 100 may include other systems as well. Alternatively, the drive control system 110, in particular the steering system 124 and the brake control system 120 may be integrated together into a motion control system which provides integrated brake and steering commands to provide motion control.

The tow vehicle 102 may move across the road surface by various combinations of movements relative to three mutually perpendicular axes defined by the tow vehicle 102: a transverse axis X_{V}, a fore-aft axis Y_{V}, and a central vertical axis Z_{V}. The transverse axis X_{V}, extends between a right side R and a left side of the tow vehicle 102. A forward drive direction along the fore-aft axis Y_{V} is designated as F_{V}, also referred to as a forward motion. In addition, an aft or rearward drive direction along the fore-aft direction Y_{V} is designated as R_{V}, also referred to as rearward motion. In some examples, the tow vehicle 102 includes a suspension system (not shown), which when adjusted causes the tow vehicle 102 to tilt about the X_{V} axis and or the Y_{V} axis, or move along the central vertical axis Z_{V}. As the tow vehicle 102 moves, the trailer 104 follows along a path of the tow vehicle 102. Therefore, when the tow vehicle 102 makes a turn as it moves in the forward direction F_{V}, then the trailer 104 follows along.

Moreover, the trailer 104 follows the tow vehicle 102 across the road surface by various combinations of movements relative to three mutually perpendicular axes defined by the trailer 104: a trailer transverse axis X_{T}, a trailer fore-aft axis Y_{T}, and a trailer central vertical axis Z_{T}. The trailer transverse axis X_{T}, extends between a right side R and a left side of the trailer 104. A forward drive direction along the trailer fore-aft axis Y_{T} is designated as F_{T}, also referred to as a forward motion. In addition, a trailer aft or rearward drive direction along the fore-aft direction Y_{T} is designated as R_{T}, also referred to as rearward motion. Therefore, movement of the vehicle-trailer system 100 includes movement of the tow vehicle 102 along its transverse axis X_{V}, fore-aft axis Y_{V}, and central vertical axis Z_{V}, and movement of the trailer 104 along its trailer transverse axis X_{T}, trailer fore-aft axis Y_{T}, and trailer central vertical axis Z_{T}. Therefore, when the tow vehicle 102 makes a turn as it moves in the forward direction F_{V}, then the trailer 104 follows along. While turning, the tow vehicle 102 and the trailer 104 form the trailer angle φ (FIG. 2B) being an angle between the vehicle fore-aft axis Y_{V} and the trailer fore-aft axis Y_{T}.

In some implementations, the vehicle 102 includes a sensor system 130 to provide sensor data 136 that may be used to determine one or more measurements, such as, a trailer length L_{T}, trailer roll T_{φ}, trailer yaw T_{ψ}, etc. In some examples, the vehicle 102 may be autonomous or semi-autonomous, therefore, the sensor system 130 provides reliable and robust autonomous driving. The sensor system 130 provides sensor data 136 and may include different types of sensors that may be used separately or with one another to create a perception of the tow vehicle's environment or a portion thereof that is used by the vehicle-trailer system 100 to identify object(s) in its environment and/or in some examples autonomously drive and make intelligent decisions based on objects and obstacles detected by the sensor system 130. In some examples, the sensor system 130 is supported by the rear portion of the tow vehicle 102 and provides sensor data 136 associated with object(s) and the trailer 104 positioned behind the tow vehicle 102. The tow vehicle 102 may support the sensor system 130; while in other examples, the sensor system 130 is supported by the vehicle 102 and the trailer 104. The sensor system 130 may include, but not limited to, one or more imaging devices 132, 132a-n (such as camera(s)), and sensors 134, 134a-n such as, but not limited to, radar, sonar, LIDAR (Light Detection and Ranging, which can entail optical remote sensing that measures properties of scattered light to find range and/or other information of a distant target), LADAR (Laser Detection and Ranging), etc.

The sensor system 130 provides sensor data 136 that includes one or both of sensor images 133 from the one or more cameras 132, 132a-n and sensor information 135 from the one or more sensors 134, 134a-n. Therefore, the sensor system 130 is especially useful for receiving information of the environment or portion of the environment of the vehicle and for increasing safety in the vehicle-trailer system 100 which may operate by the driver or under semi-autonomous or autonomous conditions.

The tow vehicle 102 may include a user interface 140, such as a display. The user interface 140 is configured to display information to the driver. In some examples, the user interface 140 is configured to receive one or more user commands from the driver via one or more input mechanisms or a touch screen display 142 and/or displays one or more notifications to the driver. In some examples, the user interface 140 is a touch screen display 142. In other examples, the user interface 140 is not a touchscreen and the driver may use an input device, such as, but not limited to, a rotary knob or a mouse to make a selection.

The tow vehicle 102 includes a stability control system 170 that communicates with at least the drive system 110, brake system 120, and sensor system 130. The stability control system 170 is in communication with a vehicle controller 150 that includes a computing device (or data processing hardware) 152 (e.g., central processing unit having one or more computing processors) in communication with non-transitory memory or hardware memory 154 (e.g., a hard disk, flash memory, random-access memory) capable of storing instructions executable on the computing processor(s)). In some example, the non-transitory memory 154 stores instructions that when executed on the computing device 152 cause the vehicle controller 150 to provide a signal or command 174 to the stability control system 170, which determines the appropriate adjustments necessary to the drive control system 110 and the brake control system 120 to maintain stability of the trailer 104.

As shown, the vehicle controller 150 is supported by the tow vehicle 102; however, the vehicle controller 150 may be separate from the tow vehicle 102 and in communication with the tow vehicle 102 via a network (not shown). In addition, the vehicle controller 150 is in communication with the sensor system 130, and receives sensor data 136 from the sensor system 130. In some examples, the vehicle controller 150 is configured to process sensor data 136 received from the sensor system 130.

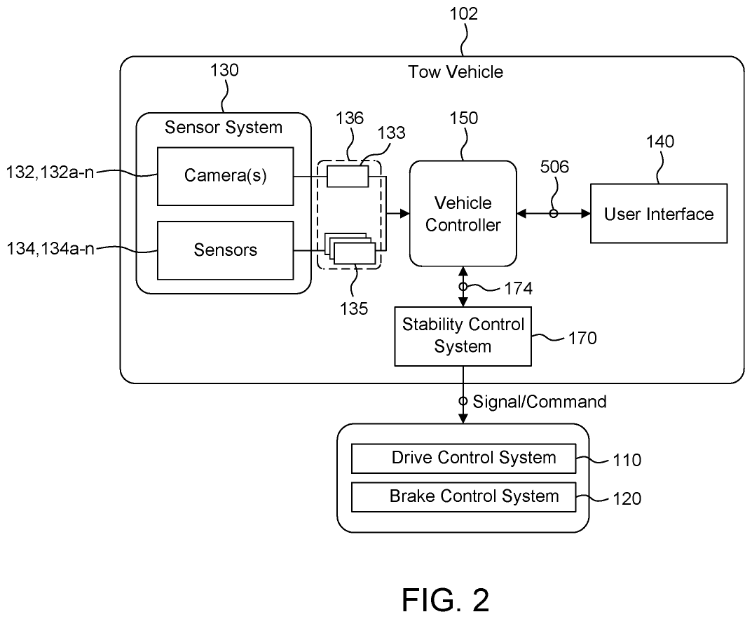

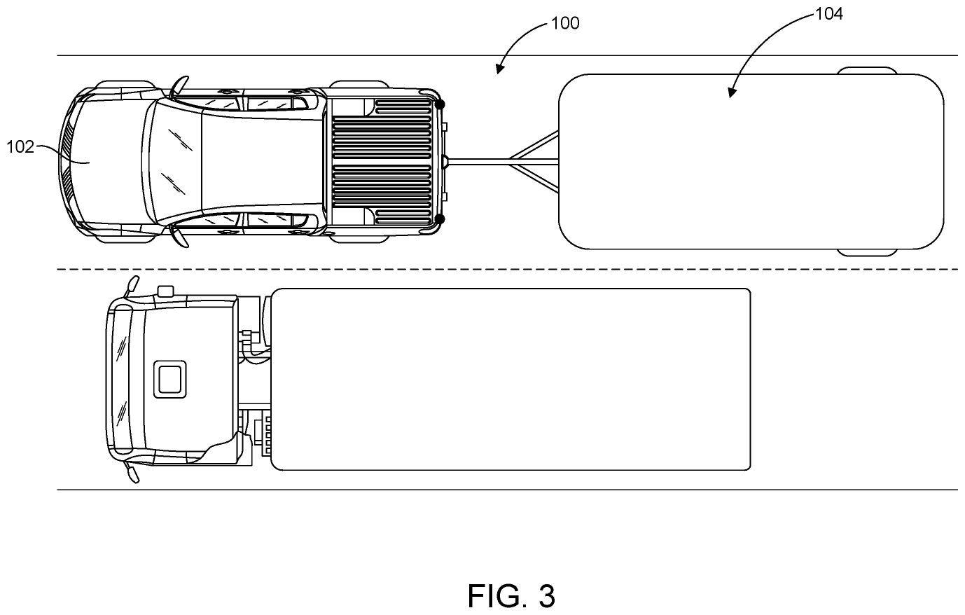

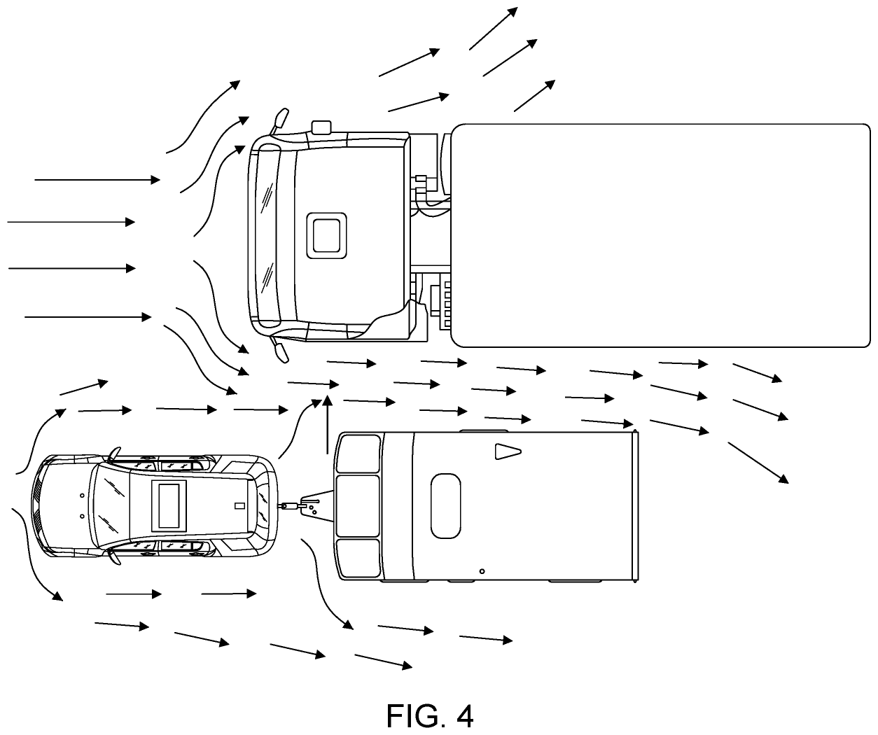

FIGS. 3 and 4 illustrate an exemplary scenario where trailer stability control may be necessary due to wind speeds generated by a passing object or the tow vehicle and trailer passing another object, in particular, where the passing object is large in size and, thus, generates high wind speed that will affect the trailer. Such high wind speed scenarios typically occur in highway situations, but other driving scenarios may also benefit from the present invention.

Further, scenarios where a change in the wind profile effecting the trailer may incur instability may also benefit from the predictive and corrective action of the control system 170 of the present invention. Such further scenarios may include wind disturbances from naturally windy weather. Map and weather data may be used to gather information for generating the wind profile in such a situation. Further, on high wind days passing large objects may create a lull in the current wind profile that can also be predicted and compensated for using the stability control system 170.

The wind profile may also use data from other sensors and systems such as map data, weather information, road conditions, tire information systems, further trailer behavior predictions and modeling.

Referring to FIGS. 1-4, the sensor system 130 can gather data including identifying objects proximate to the vehicle and being able to determine the size, speed, relative speed to the vehicle, and lateral distance to the vehicle when the objects will be passing one another. Based on this data and models of various wind scenarios for a particular vehicle, size, speed and distance the controller 150 can predict the wind forces which the trailer 104 will be subject to during the passing of the vehicles.

Based on the predicted wind forces acting on the trailer 104 the stability control system 170 can take preventative action to maintain trailer stability prior the predicted wind forces acting on the trailer, and/or also take corrective actions to be implemented during the passing of the vehicle, or if the preventative action is insufficient to maintain trailer stability.

Such preventative stability actions may include any of the following or a combination of the following: warning the driver, calculating the trailer oscillation threshold, adjusting the threshold based on the predicted wind force (e.g. reducing the threshold for corrective action), braking the tow vehicle below a critical mass moment inertia of the vehicle and trailer system or otherwise adapting the stability control sensitivity, asymmetrically braking the front axle of the tow vehicle, inducing a preventative steering oscillation (high frequency, low amplitude), and increasing a distance between the trailer and the passing vehicle. Increasing the distance between the trailer and the passing vehicle may mean moving within the current lane of travel to maximize the lateral distance between the trailer and the passing vehicle.

Further such corrective stability actions may include any of the following or a combination of the following: warning the driver, calculating the trailer oscillation threshold, adjusting the threshold based on the predicted wind force (reducing the threshold for corrective action), braking the tow vehicle below a critical mass moment inertia of the vehicle and trailer system or otherwise adapting the stability control sensitivity, asymmetrically braking the front axle of the tow vehicle, inducing a corrective counter-steering action (low frequency, high amplitude), and increasing a distance between the trailer and the passing vehicle. Increasing the distance between the trailer and the passing vehicle may mean moving within the current lane of travel to maximize the lateral distance between the trailer and the passing vehicle.

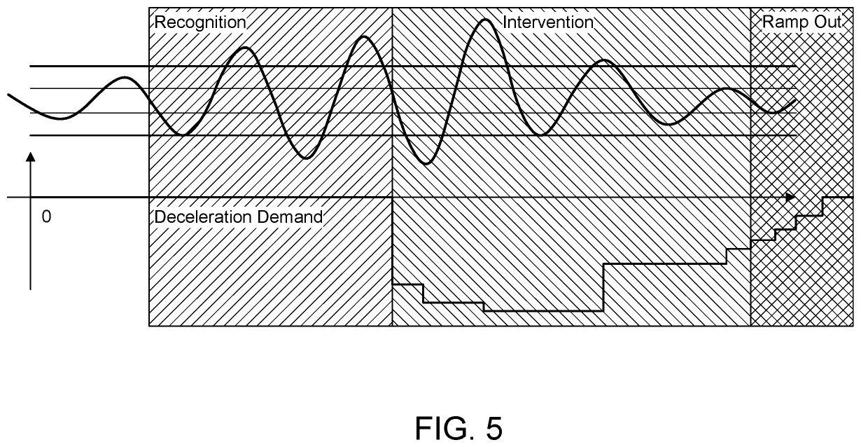

The stability control system 170 can predict the wind force and then decide if preventative action, corrective action or a combination of both should be applied. FIG. 5 illustrates an exemplary embodiment of predictive and corrective actions that can be implemented by the stability control system 170 to minimize disturbance of the trailer due to a particular wind profile. The stability control system 170 may provide a automated, or semi-automated predictive and corrective action for the vehicle and trailer system 100.

In another embodiment, the sensor data includes a lateral force from the wind on the tow vehicle and/or the trailer. In one example the wind force may be measured by sensors on the tow vehicle and the at least one preventative action may be taken prior to a substantial portion of the wind force acting upon the trailer. A substantial portion of the wind force may be defined by, the trailer oscillation threshold, a portion of the trailer oscillation threshold, e.g. one third, another defined reaction threshold, a measurable change in the lateral force acting on the trailer, or more than half. One skilled in the art would be able to determine a substation portion of lateral force due to wind prior to which preventative action may be taken.

As described herein, the tow vehicle is understood to have one engine as in a traditional combustion engine driven vehicle. However, the tow vehicle 102 may have an engine which may be electric motor, hybrid electric motor, and may contain more than motor to provide drive to the tow vehicle 102. In this instance the at least one preventative and/or corrective action may include changing a speed on one or more of the motors.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

What is claimed is:

1. A method for minimizing disturbance due to wind forces of a trailer being towed by a vehicle, the method comprising:
receiving, at a data processing hardware data from a sensor system for the tow vehicle;
determining, at the data processing hardware, a passing object profile;
predicting, at the data processing hardware, a wind force profile based upon the sensor data the passing object profile;
determining, at the data processing hardware, at least one preventative action for the vehicle to minimize the effect of disturbance on the trailer.

2. The method of claim 1, wherein the passing object profile includes at least one of: the passing object size, passing object speed, relative speed of the passing object to the vehicle, and lateral distance of the passing object to the vehicle.

3. The method of claim 1, wherein the wind force profile is determined based upon stored object data associated with the passing object profile.

4. The method of claim 1, wherein the passing object is a stationary object the vehicle is driving past.

5. The method of claim 1, wherein the at least one preventative action may include: warning a driver, calculating a trailer oscillation threshold, adjusting the trailer oscillation threshold based on the predicted wind force, braking the tow vehicle below a critical mass moment inertia of the vehicle and trailer system, adapting the stability control sensitivity, asymmetrically braking the front axle of the tow vehicle, inducing a preventative steering oscillation, increasing a distance between the trailer and the passing vehicle, and adjusting a speed of at least one motor of the tow vehicle.

6. The method of claim 5, wherein increasing the distance between the trailer and the passing vehicle further comprises moving within the current lane of travel to maximize the lateral distance between the trailer and the passing vehicle.

7. The method of claim 1, wherein the sensor data includes a lateral force from the wind on the tow vehicle and the at least one preventative action is taken prior to a substantial portion of the wind force acting upon the trailer.

8. A method for minimizing disturbance due to wind forces of a trailer being towed by a vehicle, the method comprising:
receiving, at a data processing hardware data from a sensor system for the tow vehicle, wherein the sensor data includes a lateral force from then wind on one of the tow vehicle and the trailer;
determining, at the data processing hardware, a passing object profile;
calculating, at the data processing hardware, a wind force profile based upon the sensor data the passing object profile;
determining, at the data processing hardware, at least one corrective action for the vehicle to minimize the effect of disturbance on the trailer.

9. The method of claim 8, wherein the passing object profile includes at least one of: the passing object size, passing object speed, relative speed of the passing object to the vehicle, and lateral distance of the passing object to the vehicle.

10. The method of claim 8, wherein the wind force profile is determined based upon stored object data associated with the passing object profile.

11. The method of claim 8, wherein the passing object is a stationary object the vehicle is driving past.

12. The method of claim 8, wherein the stability actions may include: calculating a trailer oscillation threshold, adjusting the trailer oscillation threshold based on the measured wind force, braking the tow vehicle below a critical mass moment inertia of the vehicle and trailer system, adapting the stability control sensitivity, asymmetrically braking the front axle of the tow vehicle, inducing a steering oscillation, increasing a distance between the trailer and the passing vehicle, and adjusting a speed of at least one motor of the tow vehicle.

13. The method of claim 12 wherein increasing the distance between the trailer and the passing vehicle further comprises moving within the current lane of travel to maximize the lateral distance between the trailer and the passing vehicle.
